(19) United States
(12) Patent Application Publication
(10) Pub. No.: US 2025/0191418 A1
(43) Pub. Date: Jun. 12, 2025

(54) MOVING BODY MANAGEMENT DEVICE, MOVING BODY CONTROL DEVICE, MOVING BODY MANAGEMENT SYSTEM, MOVING BODY MANAGEMENT METHOD, MOVING BODY CONTROL METHOD, MOVING BODY MANAGEMENT PROGRAM, AND MOVING BODY CONTROL PROGRAM

(71) Applicant: DENSO CORPORATION, Kariya-city (JP)

(72) Inventor: Masato MATSUMOTO, Kariya-city (JP)

(21) Appl. No.: 19/060,010

(22) Filed: Feb. 21, 2025

Related U.S. Application Data
(63) Continuation of application No. PCT/JP2023/023423, filed on Jun. 23, 2023.

(30) Foreign Application Priority Data
Aug. 25, 2022 (JP) 2022-134004

(51) Int. Cl. G07C 5/00; G07C 5/02

(52) U.S. Cl. CPC G07C 5/008; G07C 5/02

(57) ABSTRACT

A vehicle management system corresponding to a moving body management system includes: a vehicle management device corresponding to a moving body management device including a reception unit that receives a detection result of an occurrence status of an abnormality at a predetermined timing from a parked vehicle corresponding to a moving body whose moving function is stopped; and a vehicle control device corresponding to a moving body control device including a detection unit that detects an occurrence status of an abnormality when a vehicle corresponding to a moving body including the moving body control device is parked, and a transmission unit that transmits a detection result from a detection unit to the vehicle management device.

### CROSS-REFERENCE TO RELATED APPLICATION

The present application is a continuation application of International Application No. PCT/JP2023/023423, filed on Jun. 23, 2023, which claims priority to Japanese Patent Application No. 2022-134004, filed on Aug. 25, 2022. The contents of these applications are incorporated herein by reference in their entirety.

### BACKGROUND

### Technical Field

The present disclosure relates to a moving body management device, a moving body control device, a moving body management system, a moving body management method, a moving body control method, a moving body management program, and a moving body control program.

### Background Art

A vehicle-mounted control apparatus intended to provide a highly secure vehicle-mounted control system in preparation for cyber attacks has been proposed.

The vehicle-mounted control apparatus is included in a vehicle-mounted control system that performs autonomous driving of a vehicle, and the vehicle-mounted control system includes a plurality of driving control apparatuses for the autonomous driving of the vehicle. The vehicle-mounted control apparatus includes a regular state unit configured to switch the operating state of the vehicle-mounted control system from a regular state to a partially checking state in a case where a cyber attack has been detected in a part of the plurality of driving control apparatuses. The regular state is an operation state in which the autonomous driving is performed by using at least one of the plurality of driving control apparatuses. The partially checking state is an operating state in which the autonomous driving is performed by using at least one of the normal driving control apparatuses where a cyber attack has not been detected, and the security of each of the driving control apparatuses where the cyber attack has been detected is checked.

### SUMMARY

In the present disclosure, provided is a moving body management system as the following.

The moving body management system includes: a moving body management device including a reception unit that receives a detection result of an occurrence status of an abnormality at a predetermined timing from a moving body whose moving function is stopped; and a moving body control device including a detection unit that detects an occurrence status of an abnormality when a moving body including the moving body control device is parked, and a transmission unit that transmits a detection result from a detection unit to the moving body management device.

### BRIEF DESCRIPTION OF THE DRAWINGS

The above and other objectives, features, and advantages of the present disclosure will become more clearly apparent from the detailed description given below with reference to the accompanying drawings, in which:

FIG. 1 is a block diagram illustrating an example of functions included in devices that constitute a vehicle management system according to an embodiment;

FIG. 2 is a block diagram illustrating an example of functions included in a communication device in a vehicle control device according to the embodiment;

FIG. 3 is a block diagram illustrating an example of the hardware configuration of the vehicle management device according to the embodiment;

FIG. 4 is a block diagram illustrating an example of the hardware configuration of the communication device according to the embodiment;

FIG. 5 is a block diagram illustrating an example of the functional configuration of the vehicle management system according to the embodiment;

FIG. 6 is a schematic diagram illustrating an example of the configuration of an operation management database according to the embodiment;

FIG. 7 is a flowchart illustrating an example of a vehicle management process according to the embodiment;

FIG. 8 is a flowchart illustrating an example of an instruction timing determination process according to the embodiment;

FIG. 9 is a flowchart illustrating an example of a standard restoration time derivation process according to the embodiment;

FIG. 10 is a flowchart illustrating an example of a result analysis process according to the embodiment;

FIG. 11 is a flowchart illustrating an example of a tampering detection process according to the embodiment;

FIG. 12 is a block diagram for explaining functions included in devices that constitute a vehicle management system according to another embodiment; and

FIG. 13 is a schematic diagram for explaining processing by the vehicle management system according to the other embodiment.

### DETAILED DESCRIPTION OF THE PREFERRED EMBODIMENTS

PTL 1: WO 2020/246031

The above technique disclosed in Patent Literature 1 allows a vehicle including a plurality of driving control apparatuses to continue to operate when one or more of the plurality of driving control apparatuses are normal. As a result of detailed research, the present inventors have found that this technique does not take into account a vehicle different from the vehicle hit with a cyber attack, and when the different vehicle is hit with a similar cyber attack, this vehicle is inevitably affected.

Thus, for example, when autonomous vehicles have become widespread and services that are based on multiple autonomous vehicles are operated in the future, the proper operation of such services may be disrupted.

The above issue may arise not only for autonomous vehicles but also for common vehicles in general as well as for nonvehicular moving bodies in general, such as transport robots and drones. The issue may also arise not only from cyber attacks but also from failures in various components caused by unknown factors or various abnormalities such as software anomalies.

An object of the present disclosure is to provide a moving body management device, a moving body control device, a moving body management system, a moving body management method, a moving body control method, a moving body management program, and a moving body control program that can, in the event of an abnormality in one moving body, prevent other moving bodies from being affected.

In a first aspect of the present disclosure, a moving body management device includes a reception unit that receives the detection result of the occurrence status of an abnormality at a predetermined timing from a moving body whose moving function is stopped.

In a second aspect of the present disclosure, a moving body control device includes: a detection unit that detects the occurrence status of an abnormality when a moving function of a moving body including the moving body control device is stopped; and a transmission unit that transmits the detection result from the detection unit to a moving body management device.

In a third aspect of the present disclosure, a moving body management system includes: a moving body management device including a reception unit that receives the detection result of the occurrence status of an abnormality at a predetermined timing from a moving body whose moving function is stopped; and a moving body control device including a detection unit that detects the occurrence status of an abnormality when a moving function of a moving body including the moving body control device is stopped, and a transmission unit that transmits the detection result from the detection unit to the moving body management device.

In a fourth aspect of the present disclosure, a moving body management method includes receiving the detection result of the occurrence status of an abnormality at a predetermined timing from a moving body whose moving function is stopped.

In a fifth aspect of the present disclosure, a moving body control method includes: detecting the occurrence status of an abnormality when a moving function of a moving body including the moving body control device is stopped; and transmitting the detection result to a moving body management device.

In a sixth aspect of the present disclosure, a moving body management method includes: by a moving body management device, receiving the detection result of the occurrence status of an abnormality at a predetermined timing from a moving body whose moving function is stopped; and by a moving body control device, detecting the occurrence status of an abnormality when a moving function of a moving body including the moving body control device is stopped, and transmitting the detection result to the moving body management device.

In a seventh aspect of the present disclosure, a moving body management program causes a computer to receive the detection result of the occurrence status of an abnormality at a predetermined timing from a moving body whose moving function is stopped.

In an eighth aspect of the present disclosure, a moving body control program causes a computer to: detect the occurrence status of an abnormality when a moving function of a moving body including the moving body control device is stopped; and transmit the detection result to a moving body management device.

The moving body management device, the moving body control device, the moving body management system, the moving body management method, the moving body control method, the moving body management program, and the moving body control program according to the present disclosure can, in the event of an abnormality in one moving body, prevent other moving bodies from being affected.

Exemplary embodiments of the present disclosure will now be described in detail with reference to the drawings. The following describes the abnormality in the present disclosure as cyberattack-induced tampering with various programs executed by electronic control units (ECUs). The following also describes a case in which the present disclosure is applied to a system for vehicle management (hereinafter referred to as a vehicle management system) used in service companies each owning multiple vehicles (corresponding to moving bodies in the present disclosure) and providing services that are based on the multiple vehicles. Examples of the above services include a delivery service, a dispatch service, and a bus service, and the above service companies include a delivery company, a taxi company, and a bus company.

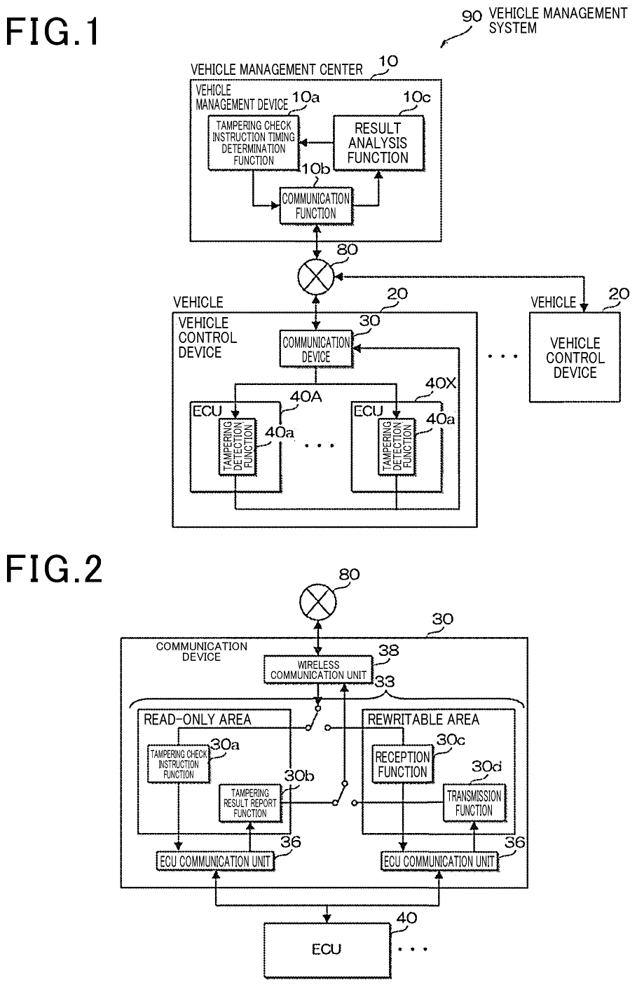

First, the functions of devices constituting a vehicle management system 90 corresponding to a moving body management system according to the present embodiment will be described with reference to FIG. 1.

As illustrated in FIG. 1, the vehicle management system 90 according to the present embodiment includes a vehicle management device 10 corresponding to a moving body management device installed in a predetermined vehicle management center and vehicle control devices 20 corresponding to moving body control devices included on a one-to-one basis in multiple vehicles managed by the vehicle management device 10 (hereinafter simply referred to as vehicles). The vehicle management device 10 and the vehicle control devices 20 can access each other through a network 80. Examples of the vehicle management device 10 include general-purpose information processing devices such as personal computers and server computers.

As illustrated in FIG. 1, the vehicle management device 10 according to the present embodiment includes a tampering check instruction timing determination function 10a, a communication function 10b, and a result analysis function 10c.

The tampering check instruction timing determination function 10a according to the present embodiment performs an instruction timing determination process described later to determine when to instruct each of the multiple managed vehicles to check for tampering with various programs executed by ECUs 40A to 40X. Hereinafter, when each of the ECUs 40A to 40X is described without distinction, the ECUs are collectively referred to as the ECUs 40.

The communication function 10b according to the present embodiment communicates with the multiple vehicles through the network 80. The communication function 10b according to the present embodiment transmits an instruction to check for tampering with the various programs to each vehicle at the time determined by the tampering check instruction timing determination function 10a, and receives detection results described later transmitted from the vehicle in response to the instruction.

The result analysis function 10c according to the present embodiment performs a result analysis process described in detail later for analyzing the detection results received by the communication function 10b. Based on the analysis results from the result analysis function 10c, the tampering check instruction timing determination function 10a according to the present embodiment determines when to issue the above-mentioned instruction to check for tampering.

Next, as illustrated in FIG. 1, the vehicle control device 20 according to the present embodiment includes a communication device 30 that communicates with the vehicle management device 10 and also communicates with the multiple ECUs 40 in the vehicle in which the device is installed.

The ECUs 40 according to the present embodiment each include a tampering detection function 40a for detecting tampering with the programs executed by the ECU. In the present embodiment, the tampering detection by the tampering detection function 40a is performed with the secure boot function conventionally incorporated in the vehicle but may be performed otherwise. For example, a dedicated program for detecting tampering with the above programs may be created and used.

The communication device 30 according to the present embodiment then transmits an instruction for the tampering detection function 40a to check for tampering (hereinafter referred to as a tampering check instruction) to each of the ECUs 40, receives tampering detection results provided by each ECU 40 in response to the tampering check instruction (hereinafter simply referred to as detection results), and transmits the received detection results to the vehicle management device 10.

Next, the functions of the communication device 30 in the vehicle control device 20 according to the present embodiment will be described with reference to FIG. 2.

As illustrated in FIG. 2, the communication device 30 according to the present embodiment includes, as described later, an ECU communication unit 36 that communicates with the ECUs 40 and a wireless communication unit 38 that communicates wirelessly with the vehicle management device 10 through the network 80.

As illustrated in FIG. 2, the communication device 30 according to the present embodiment also includes a tampering check instruction function 30a, a tampering result report function 30b, a reception function 30c, and a transmission function 30d.

The tampering check instruction function 30a according to the present embodiment transmits the above-described tampering check instruction to each ECU 40 through the ECU communication unit 36 when receiving the instruction to check for tampering from the vehicle management device 10. When receiving the tampering check instruction, as described above, the ECU 40 detects the presence or absence of tampering using its own tampering detection function 40a and transmits the detection results to the tampering result report function 30b through the ECU communication unit 36.

The tampering result report function 30b according to the present embodiment transmits the received detection results to the vehicle management device 10 through the wireless communication unit 38. As described above, the vehicle management device 10 executes the result analysis process with the result analysis function 10c using the detection results transmitted from the tampering result report function 30b.

Meanwhile, the reception function 30c according to the present embodiment receives a variety of normal instructions from the vehicle management device 10 to the ECU 40 through the wireless communication unit 38 and transmits the received instructions to the ECU 40 through the ECU communication unit 36. When receiving the instructions, the ECU 40 executes the processing corresponding to the received instructions and transmits the execution results to the transmission function 30d through the ECU communication unit 36.

The transmission function 30d according to the present embodiment transmits the execution results received from the ECU communication unit 36 to the vehicle management device 10 through the wireless communication unit 38.

That is, the reception function 30c and the transmission function 30d according to the present embodiment are the functions conventionally included in the communication device 30 (hereinafter referred to as the existing functions). In contrast, the tampering check instruction function 30a and the tampering result report function 30b according to the present embodiment are functions newly included for implementing the present disclosure (hereinafter referred to as the new functions). In the communication device 30 according to the present embodiment, the existing functions are implemented normally, and the new functions are implemented at the above-described time to check for tampering.

Thus, in the communication device 30 according to the present embodiment, programs for implementing the new functions are stored in a read-only area in a storage 33 described later, whereas programs for implementing the existing functions are stored in a rewritable area in the storage 33. This configuration allows the existing functions to be revised as appropriate and can significantly reduce the likelihood of the new functions being tampered with.

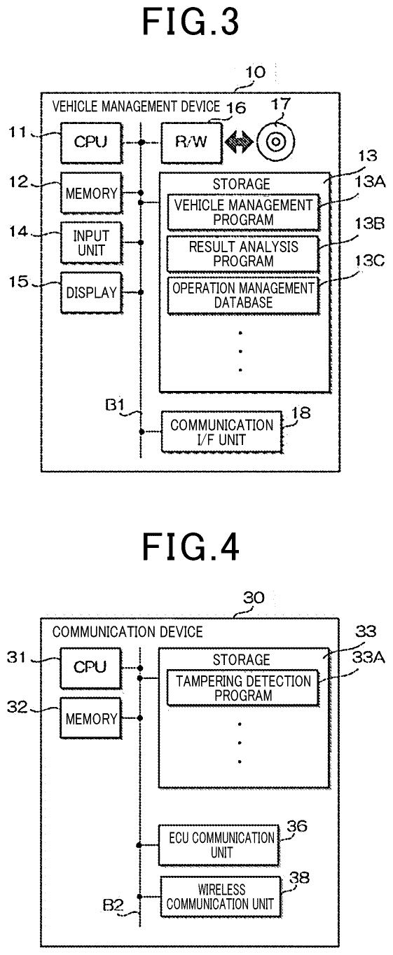

Next, the hardware configuration of the vehicle management device 10 according to the present embodiment will be described with reference to FIG. 3.

The vehicle management device 10 according to the present embodiment includes a central processing unit (CPU) 11, a memory 12 as a temporary storage area, a nonvolatile storage 13, an input unit 14 such as a keyboard or a mouse, a display 15 such as a liquid crystal display, a media reader-writer (R/W) 16, and a communication interface (I/F) unit 18. The CPU 11, the memory 12, the storage 13, the input unit 14, the display 15, the media reader-writer 16, and the communication I/F unit 18 are connected to each other with a bus B1. The media reader-writer 16 reads information written in a recording medium 17 and writes information into the recording medium 17.

The storage 13 is implemented by, for example, a hard disk drive (HDD), a solid state drive (SSD), or a flash memory. The storage 13 as a storage medium stores a vehicle management program 13A corresponding to a moving body management program and a result analysis program 13B. The vehicle management program 13A and the result analysis program 13B are each stored (installed) into the storage 13 when the recording medium 17 in which the program is written is set in the media reader-writer 16 and the media reader-writer 16 reads the corresponding program from the recording medium 17. The CPU 11 reads each of the vehicle management program 13A and the result analysis program 13B as appropriate from the storage 13, loads the read program into the memory 12, and sequentially executes the processes of the program.

The storage 13 also stores an operation management database 13C. The operation management database 13C is described in detail later.

Next, the hardware configuration of the communication device 30 according to the present embodiment will be described with reference to FIG. 4.

The communication device 30 according to the present embodiment includes a CPU 31, a memory 32 as a temporary storage area, the nonvolatile storage 33, the above-described ECU communication unit 36, and the wireless communication unit 38. The CPU 31, the memory 32, the storage 33, the ECU communication unit 36, and the wireless communication unit 38 are connected to each other with a bus B2.

The storage 33 is implemented by, for example, an HDD, an SSD, or a flash memory. The storage 33 as a storage medium stores a tampering detection program 33A corresponding to a moving body control program in the present disclosure. The storage 33 according to the present embodiment has the rewritable area and the read-only area as described above, and the tampering detection program 33A is stored (installed) in the read-only area of the storage 33 when the communication device 30 is produced. The CPU 31 reads the tampering detection program 33A as appropriate from the storage 33, loads the read program into the memory 32, and sequentially executes the processes of the tampering detection program 33A.

Next, the functional configuration of the devices included in the vehicle management system 90 according to the present embodiment will be described with reference to FIG. 5.

As illustrated in FIG. 5, the vehicle management device 10 according to the present embodiment includes an instruction unit 11A and a reception unit 11B. The CPU 11 of the vehicle management device 10 executes the vehicle management program 13A and the result analysis program 13B to function as the instruction unit 11A and the reception unit 11B.

The vehicle control device 20 according to the present embodiment includes a detection unit 21A and a transmission unit 21B. The CPU 31 of the communication device 30 included in the vehicle control device 20 executes the tampering detection program 33A to function as the detection unit 21A and the transmission unit 21B.

The instruction unit 11A according to the present embodiment instructs the vehicle control device 20 at a predetermined timing to transmit detection results. In the present embodiment, as described above, the predetermined timing is the time determined by the tampering check instruction timing determination function 10a. Furthermore, in the present embodiment, as described above, the instruction to transmit the detection results is the above-described instruction to check for tampering.

On the other hand, when receiving an instruction to transmit the detection results with the vehicle parked, the detection unit 21A according to the present embodiment detects the occurrence status of abnormality (in the present embodiment, the above-described tampering). The transmission unit 21B according to the present embodiment then transmits the detection results from the detection unit 21A to the vehicle management device 10. The term “vehicle parked” refers to the vehicle stopped with its own control device (in the present embodiment, the components of the vehicle control device 20 except for the communication device 30) being stopped (including being in sleep mode).

On the other hand, the reception unit 11B according to the present embodiment receives the detection results from the parked vehicle.

When the detection results received by the reception unit 11B indicate that an abnormality has occurred, the instruction unit 11A according to the present embodiment instructs vehicles related (hereinafter referred to as related vehicles) to the vehicle that has transmitted the detection results (hereinafter referred to as the sender vehicle) to detect the occurrence status of the abnormality.

In the present embodiment, the related vehicles include, among the vehicles managed by the vehicle management system 90 except the sender vehicle, vehicles owned by the service company owning the sender vehicle (hereinafter referred to as first related vehicles). In the present embodiment, the related vehicles also include, among the vehicles managed by the vehicle management system 90 except the sender vehicle, vehicles incorporating the same model of ECU 40 as the sender vehicle (hereinafter referred to as second related vehicles). Furthermore, in the present embodiment, the related vehicles include, among the vehicles managed by the vehicle management system 90 except the sender vehicle, vehicles positioned in the zone where the sender vehicle is parked (hereinafter referred to as third related vehicles). However, the related vehicles are not limited to the first to third related vehicles. For example, among the vehicles managed by the vehicle management system 90, all the vehicles except the sender vehicle may be defined as the related vehicles, or the same model of vehicles as the sender vehicle may be defined as the related vehicles.

In the present embodiment, when an abnormality has occurred, the detection results include detection information required to locate the abnormality (in the present embodiment, information identifying the ECU 40 that executes the program in which tampering is detected). Thus, when tampering has occurred, the vehicle management device 10 can refer to the detection information received from the vehicle control device 20 to determine the location of the tampering.

When receiving no response for a predetermined period or longer from a vehicle that has accepted the instruction from the instruction unit 11A (hereinafter referred to as the instructed vehicle), the instruction unit 11A according to the present embodiment further instructs vehicles of similar type (hereinafter referred to as a similar type of vehicles) to detect the occurrence status of the abnormality.

In the present embodiment, the similar type of vehicles include, among the vehicles managed by the vehicle management system 90 except the instructed vehicle, vehicles incorporating the same model of ECU 40 as the instructed vehicle. However, the similar type of vehicles are not limited to these vehicles. For example, among the vehicles managed by the vehicle management system 90, the same model of vehicles as the instructed vehicle may be defined as the similar type of vehicles.

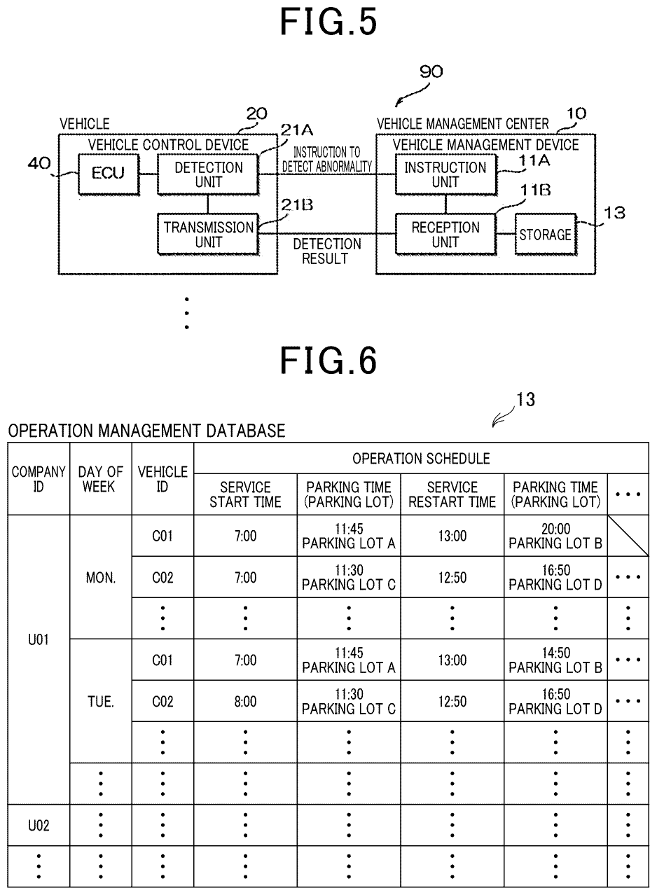

Next, the operation management database 13C according to the present embodiment will be described with reference to FIG. 6.

As illustrated in FIG. 6, the operation management database 13C according to the present embodiment stores information: company identification (ID), day, vehicle ID, and operation schedule.

The company ID is information given in advance to identify the above-described service companies, with different company IDs assigned to different service companies. The day is information indicating the day of the week, and the vehicle ID is information given in advance to identify the vehicles managed by the vehicle management system 90, with different vehicle IDs assigned to different vehicles. The operation schedule is information indicating the operation schedule for each vehicle of each service company on each day of the week, storing information: service start time, parking time (parking lot), service restart time, parking time (parking lot), and so on.

In the example shown in FIG. 6, the stored information indicates that, for example, the vehicle with the vehicle ID “C01” owned by the service company with the company ID “U01” starts service (operating) at 7 in the morning on Monday, and the vehicle is in service until 11:45 and then parked in parking lot A. In the example shown in FIG. 6, the stored information also indicates that the vehicle resumes service at 13:00, and after that, the vehicle is in service until 20:00 and then parked in parking lot B.

Although not illustrated, in addition to the operation management database 13C, the storage 13 in the vehicle management device 10 according to the present embodiment also holds a restoration staff database indicating the positions (hereinafter referred to as the locations) of multiple operators for restoring tampered programs (hereinafter referred to as the restoration staff). Although not illustrated, the storage 13 in the vehicle management device 10 according to the present embodiment also holds a restoration time database storing time for restoring the tampered program (in the present embodiment, the time required to write (update) each program and hereinafter referred to as the writing time) for each type of program. In addition to the above database, the storage 13, as described later, further holds various databases, which will not be described.

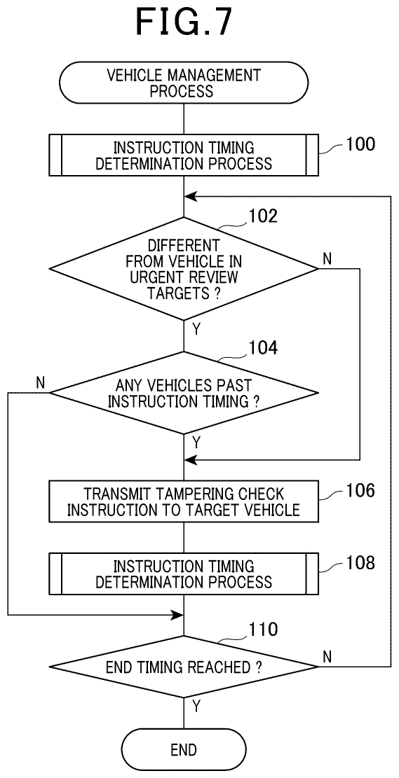

Next, the operation of the vehicle management system 90 according to the present embodiment will be described with reference to FIGS. 7 to 11. To avoid confusion, the following describes a case in which the above-described various databases are built. In the case described here, the locations of the restoration staff in the restoration staff database are updated as appropriate, and the restoration time database is also updated as appropriate so that the program writing times are the latest.

First, the operation of the vehicle management device 10 for implementing a vehicle management process is described with reference to FIGS. 7 to 9 as the operation of the vehicle management device 10 according to the present embodiment. The CPU 11 of the vehicle management device 10 executes the vehicle management program 13A to implement the vehicle management process illustrated in FIG. 7. For example, the vehicle management process illustrated in FIG. 7 starts at a predetermined date and time at which the vehicle management system 90 starts vehicle management (in the present embodiment, 6 a.m. on weekdays).

In the present embodiment, the implementation of the vehicle management process is scheduled to start at 6 a.m. on weekdays because tampering may be conducted late at night after the end of the service companies' operating hours. That is, the vehicle management system 90 according to the present embodiment assumes that each service company's business starts at 7 a.m. on weekdays, and even if tampering is conducted late at night as described above, 6 a.m. is a time having a sufficient margin to complete the restoration before 7 a.m. on the same day. However, the vehicle management process according to the present embodiment may not be implemented in this way, but may be, for example, implemented at all times, or the vehicle management process may be scheduled to start at the date and time determined by counting back, from the business start time, a standard restoration time or longer derived from a standard restoration time derivation process described later.

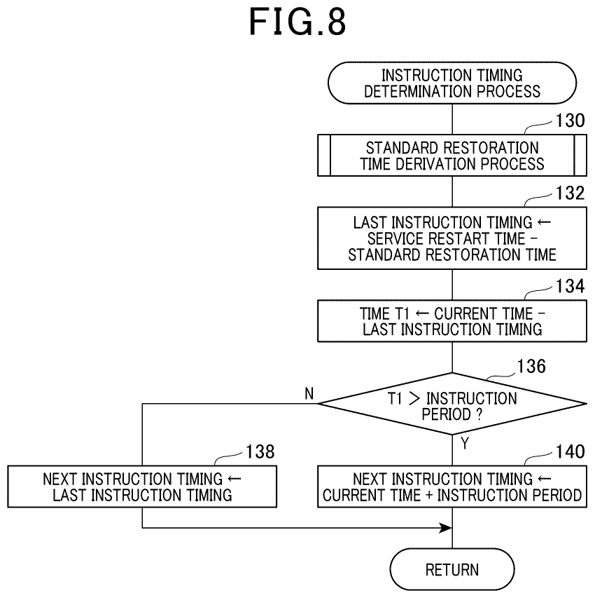

In step 100 in FIG. 7, the CPU 11 implements an instruction timing determination process configured as a subroutine program in the vehicle management program 13A for, among the vehicles managed by the vehicle management system 90 (hereinafter referred to as the management target vehicles), any vehicle parked at this point in time (hereinafter referred to as the parked target vehicle). The instruction timing determination process according to the present embodiment will now be described with reference to FIG. 8.

In the present embodiment, it is determined whether a vehicle is parked by referring to the operation management database 13C to determine whether this point in time is within a time period during which the vehicle is parked, but the parking status may be determined otherwise. For example, with a location system such as GPS (global positioning system) installed in all the management target vehicles, it may be determined whether a vehicle is parked by determining whether the position determined by the location system is within a parking lot. Alternatively, for example, it may be determined whether a vehicle is parked by asking the vehicle whether the vehicle is parked and determining the parking status based on the response.

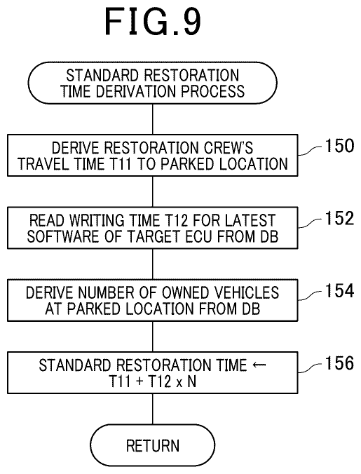

In step 130 in FIG. 8, the CPU 11 implements, for the parked target vehicle, the standard restoration time derivation process configured as a subroutine program in the instruction timing determination process. The standard restoration time derivation process according to the present embodiment will now be described with reference to FIG. 9.

In step 150 in FIG. 9, the CPU 11 refers to the operation management database 13C to determine the parked location of the parked target vehicle (in the present embodiment, a parking lot) as well as refers to the restoration staff database to determine the position of the restoration staff member nearest to the determined location of the parked target vehicle. The CPU 11 then uses the determined location of the parked target vehicle and the determined position of the restoration staff member to derive the travel time T11 taken for the restoration staff member to arrive at the location of the parked target vehicle.

In step 152, the CPU 11 reads, from the restoration time database, the writing time T12 for the program to be executed by the ECU 40 incorporated in the parked target vehicle. In step 154, the CPU 11 refers to the operation management database 13C to determine the number of vehicles parked in the same parking lot as the parked target vehicle (hereinafter referred to as the number of owned vehicles) N.

In step 156, the CPU 11 substitutes the travel time T11, the writing time T12, and the number of owned vehicles N obtained in the above processes into equation (1) below to calculate the standard restoration time TS, before ending this standard restoration time derivation process. The standard restoration time TS derived in the standard restoration time derivation process represents, in a case in which the tampering is detected in the parked target vehicle, the expected time taken to restore all the management target vehicles parked in the same parking lot as the parked target vehicle.

$$TS = T 11 + T 12 \times N \qquad ( 1 )$$

When the standard restoration time derivation process is ended, the processing proceeds to step 132 in the instruction timing determination process illustrated in FIG. 8.

In step 132 in FIG. 8, the CPU 11 reads the nearest service restart time RT of the parked target vehicle from the operation management database 13C. The CPU 11 then substitutes the read service restart time RT and the standard restoration time TS obtained in the standard restoration time derivation process into equation (2) to calculate the last instruction timing LCT. The calculated last instruction timing LCT represents, in a case in which the tampering is detected in the parked target vehicle, the last point in time to give a tampering check instruction at which all the management target vehicles parked in the same parking lot as the parked target vehicle can be restored before the parked target vehicle restarts operation.

$$LCT = RT - TS \qquad ( 2 )$$

To avoid confusion, equation (2) assumes that tampering is detected after the completion of the operation of the parked target vehicle and before the restart of the operation during the service companies' operating hours, but tampering may be detected otherwise. For example, tampering may be assumed to be detected after the end of the service companies' operating hours and before the next day's business start time. In this case, the last instruction timing LCT is calculated from the following equation.

$$LCT = Service start time - TS$$

In step 134, the CPU 11 substitutes the time at this point (hereinafter referred to as the current time) CT and the last instruction timing LCT into equation (3) below to calculate the time T1. When the last instruction timing LCT is after the current time CT, the calculated time T1 is the period of time from the current time CT to the last instruction timing LCT. When the last instruction timing LCT is before the current time CT, the calculated time T1 is the period of time obtained by counting back the last instruction timing LCT from the current time CT. When the current time CT is equal to the last instruction timing LCT, the time T1 is 0 (zero).

$$T 1 = CT - LCT \qquad ( 3 )$$

In step 136, the CPU 11 determines whether the time T1 is longer than the predefined period of instruction to detect tampering (in the present embodiment, 10 minutes, hereinafter referred to as the instruction period), and if a negative determination result is provided, the CPU 11 advances to step 138. In step 138, the CPU 11 sets the last instruction timing LCT to the next instruction timing and then ends this instruction timing determination process.

In the present embodiment, as described above, the instruction period is 10 minutes because tampering is assumed to be detected after the completion of the operation of the parked target vehicle and the before the restart of the operation during the service companies' operating hours, but any other instruction period may be used. For example, as described above, when tampering is assumed to be detected after the end of the service companies' operating hours and before the next day's business start, the instruction period may be 24 hours. This allows a tampering check to be performed at least once a day even when the parked target vehicle is not used a few days.

In contrast, if a positive determination result is provided in step S136, or in other words, the time T1 is longer than the instruction period, the CPU 11 advances to step S140, in which the CPU 11 sets the sum of the current time CT and the instruction period to the next instruction timing and then ends this instruction timing determination process.

When the instruction timing determination process is ended, the processing proceeds to step S102 in the vehicle management process illustrated in FIG. 7 (main routine).

In step S102 in FIG. 7, the CPU 11 determines whether the parked target vehicle is different from a vehicle in urgent review targets determined in a result analysis process described in detail later, and if a negative determination result is provided, the CPU 11 advances to step S106. In contrast, if a positive determination result is provided, the CPU 11 advances to step S104.

In step S104, the CPU 11 determines whether any vehicle meets the next instruction timing derived in the instruction timing determination process (hereinafter referred to as the vehicle to be instructed), and if a negative determination result is provided, the CPU 11 advances to step S110. In contrast, if a positive determination result is provided, the CPU 11 advances to step S106. In step 106, the CPU 11 transmits the instruction to check for tampering to the vehicle to be instructed.

In step 108, the CPU 11 implements the above-described instruction timing determination process in the same manner as in step S100. In step S110, the CPU 11 determines whether the end timing predetermined as the time to end this vehicle management process has come, and if a negative determination result is provided, the CPU 11 advances to step S102. In contrast, if a positive determination result is provided, the CPU 11 ends this vehicle management process. In the present embodiment, the end timing is the predetermined date and time (in the present embodiment, 10 p.m. on weekdays) at which the vehicle management system 90 ends the management of the management target vehicles, but any other time may of course be selected.

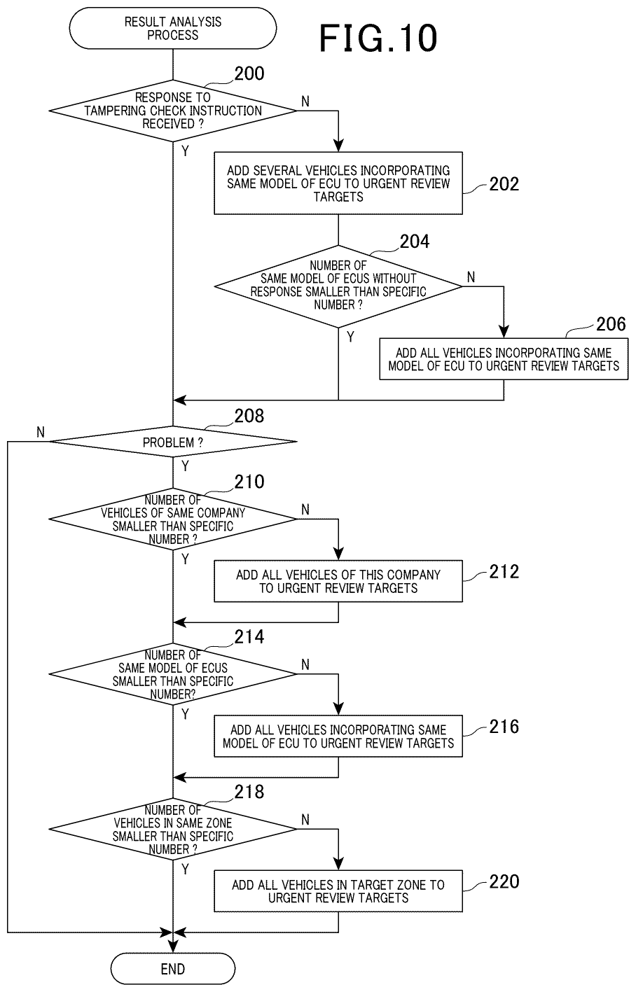

Next, the operation of the vehicle management device 10 for implementing a result analysis process is described with reference to FIG. 10 as the operation of the vehicle management device 10 according to the present embodiment. The CPU 11 of the vehicle management device 10 executes the result analysis program 13B to implement the result analysis process illustrated in FIG. 10. The result analysis process illustrated in FIG. 10 is implemented after the instruction to check for tampering is transmitted in the above-described vehicle management process.

In step S200 in FIG. 10, the CPU 11 determines whether information indicating a response to the instruction to check for tampering transmitted in the vehicle management process (corresponding to response information described later) is received within a predetermined period (in the present embodiment, 10 seconds), and if a positive determination result is provided, the CPU 11 advances to step S208. In contrast, if a negative determination result is provided in step S200, that is, no response information is received within the predetermined period, the CPU 11 advances to step S202.

In step S202, the CPU 11 adds, to the above-described urgent review targets, several (in the present embodiment, five) of the management target vehicles incorporating the same model of ECU 40 as the ECU 40 incorporated in the instructed vehicle. In the present embodiment, the management target vehicles incorporating the same model of ECU 40 are identified using a database built in advance as a database that contains information representing the relationship between management target vehicles and the models of the ECUs 40 incorporated in the management target vehicles, but any other method may of course be used.

In step S204, the CPU 11 determines whether, among the vehicles incorporating the same model of ECU 40, the number of vehicles that return no response during the predetermined period is smaller than a specific number (in the present embodiment, three), and if a positive determination result is provided, the CPU 11 advances to step S208. In contrast, if a negative determination result is provided, the CPU 11 advances to step S206.

In step S206, the CPU 11 adds all the management target vehicles incorporating the same model of ECU 40 to the urgent review targets and then advances to step S208.

In step S208, the CPU 11 determines whether information indicating that the tampering is detected (hereinafter referred to as the detection result information) is received as information indicating the detection results or whether no response information is received within the predetermined period. Hereinafter, a vehicle that has transmitted the detection result information and a vehicle that has transmitted no response information within the predetermined period are referred to as abnormal vehicles. If the determination provides a negative determination result, the CPU 11 ends this result analysis process. In contrast, if a positive determination result is provided, the CPU 11 advances to step S210.

In step S210, the CPU 11 determines whether the number of abnormal vehicles of the same service company as the instructed vehicle is smaller than a specific number (in the present embodiment, 10), and if a positive determination result is provided, the CPU 11 advances to step S214. In contrast, if a negative determination result is provided, the CPU 11 advances to step S212.

In step S212, the CPU 11 adds all the vehicles of the service company owning the instructed vehicle to the urgent review targets and then advances to step S214. In the present embodiment, the vehicles of the same service company are identified by referring to the operation management database 13C, but any other method may of course be used.

In step S214, the CPU 11 determines whether the number of abnormal vehicles incorporating the same model of ECU 40 as the instructed vehicle is smaller than a specific number (in the present embodiment, 10), and if a positive determination result is provided, the CPU 11 advances to step S218. In contrast, if a negative determination result is provided, the CPU 11 advances to step S216.

In step S216, the CPU 11 adds, to the urgent review targets, all the management target vehicles incorporating the same model of ECU 40 as the ECU 40 that executes the program in which the tampering is detected, and then advances to step S218.

In step S218, the CPU 11 determines whether the number of abnormal vehicles positioned in the same zone as the instructed vehicle is smaller than a specific number (in the present embodiment, five), and if a positive determination result is provided, the CPU 11 ends this result analysis process. In contrast, if a negative determination result is provided, the CPU 11 advances to step S220. Here, a zone in which the number of abnormal vehicles is greater than or equal to the specific number is referred to as the target zone. In the present embodiment, the abnormal vehicles present in the target zone are identified by referring to the operation management database 13C, but any other method may of course be used.

In step S220, the CPU 11 adds all the management target vehicles present in the target zone to the urgent review targets and then ends this result analysis process.

The vehicles added to the urgent review targets by the processing in step S202 and step 206 of this result analysis process correspond to the above-described similar type of vehicles. The vehicles added to the urgent review targets by the processing in step S212 correspond to the first related vehicles. The vehicles added to the urgent review targets by the processing in step S216 correspond to the second related vehicles. The vehicles added to the urgent review targets by the processing in step S218 correspond to the third related vehicles.

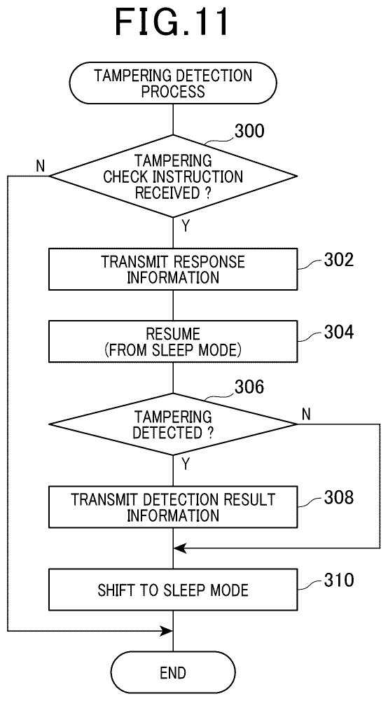

Next, the operation of the vehicle control device 20 for implementing a tampering detection process is described with reference to FIG. 11 as the operation of the vehicle control device 20 according to the present embodiment. The CPU 31 of the communication device 30 included in the vehicle control device 20 executes the tampering detection program 33A to implement the tampering detection process illustrated in FIG. 11. The tampering detection process illustrated in FIG. 11 is implemented at each predetermined timing (in the present embodiment, every predetermined period (for example, 10 seconds)).

In step S300 in FIG. 11, the CPU 31 determines whether the instruction to check for tampering is received from the vehicle management device 10, and if a negative determination result is provided, the CPU 31 ends this tampering detection process. In contrast, if a positive determination result is provided, the CPU 31 advances to step S302.

In step S302, the CPU 31 transmits response information about the reception of the instruction to check for tampering to the vehicle management device 10. In step S304, the CPU 31 resumes each component of the vehicle control device 20 incorporating the CPU 31 from sleep mode. In the process of resumption from sleep mode, each of the ECUs 40 uses the above-described secure boot function to activate the tampering detection function 40a for detecting tampering with programs executed by the ECU 40.

Thus, in step S306, the CPU 31 determines whether the tampering detection function 40a in at least one ECU 40 has detected tampering, and if a negative determination result is provided, the CPU 31 advances to step S310. In contrast, if a positive determination result is provided, the CPU 31 advances to step S308.

In step S308, the CPU 31 transmits detection result information indicating that tampering is detected to the vehicle management device 10 together with information identifying the ECU 40 that executes the program in which tampering is detected (corresponding to the above-described detection information). In step S310, the CPU 31 shifts each component of the vehicle control device 20 into sleep mode and then ends this tampering detection process.

Thus, in the vehicle control device 20 according to the present embodiment, since each of the ECUs 40 resumes from sleep mode in response to an instruction from the communication device 30, the communication device 30 and the ECUs 40 have a mechanism for this purpose. However, this is not restrictive, and even when the communication device 30 is in sleep mode, the communication device 30 may be resumed remotely. Even when the entire vehicle control device 20 is in sleep mode, this system allows the ECUs 40 to be resumed remotely from the sleep mode.

As described above, the vehicle management device 10 according to the present embodiment receives the detection results of the occurrence status of an abnormality at a predetermined timing from a parked vehicle. Thus, in the event of an abnormality in a vehicle, the use of the received detection results can prevent other vehicles from being affected.

Furthermore, when the received detection results indicate that an abnormality has occurred, the vehicle management device 10 according to the present embodiment instructs a vehicle related to the vehicle to detect the occurrence status of the abnormality. Thus, in the event of an abnormality in a vehicle, other vehicles can be more reliably prevented from being affected.

Furthermore, according to the vehicle management device 10 according to the present embodiment, in the event of the abnormality, the detection results include detection information required to locate the abnormality. Thus, other vehicles can be prevented from being affected at the corresponding location where the abnormality has occurred.

Furthermore, the vehicle management device 10 according to the present embodiment gives an instruction to transmit the detection results at a predetermined timing, and without a response for a predetermined period or longer from a vehicle that has accepted the instruction, further instructs a similar type of vehicles to detect the occurrence status of the abnormality. Thus, the occurrence of an abnormality can be detected based on the response status for an instruction to transmit the detection results.

Furthermore, the vehicle control device 20 according to the present embodiment detects the occurrence status of an abnormality when the corresponding vehicle is parked, and transmits the detection results to the vehicle management device 10. Thus, in the event of an abnormality in a vehicle, the use of the detection results received by the vehicle management device 10 can prevent other vehicles from being affected.

Furthermore, in the event of an abnormality, the vehicle control device 20 according to the present embodiment performs the detection to provide detection information required to locate the abnormality. Thus, the use of the detection information received by the vehicle management device 10 can prevent other vehicles from being affected at the corresponding location where the abnormality has occurred.

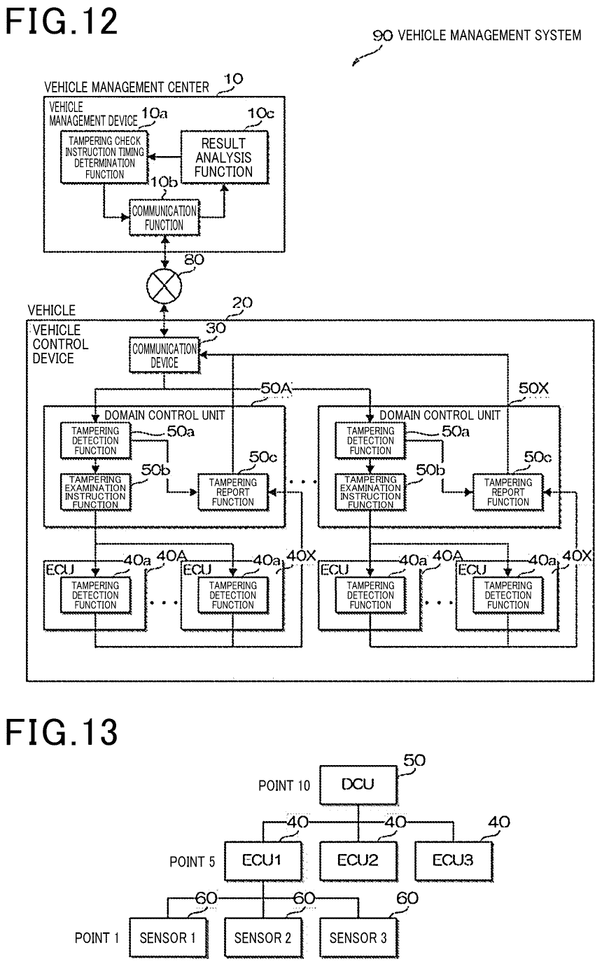

Although vehicles that perform domain control are not mentioned in the above embodiment, the present disclosure may also be directed to a vehicle that performs domain control, as exemplarily illustrated in FIG. 12. In FIG. 12, the same components as illustrated in FIG. 1 are assigned the same reference signs as in FIG. 1. To avoid confusion, the vehicle control device 20 in a single vehicle is illustrated in FIG. 12, but actually the present disclosure is directed to the vehicle control devices 20 in multiple vehicles.

As illustrated in FIG. 12, the ECUs 40 in this embodiment are classified into multiple groups, and domain control units 50A to 50X are provided for the groups on a one-to-one basis. Hereinafter, when each of the domain control units 50A to 50X is described without distinction, the domain control units are collectively referred to as the domain control units 50.

Each domain control unit 50 includes a tampering detection function 50a, a tampering examination instruction function 50b, and a tampering report function 50c.

The tampering detection function 50a according to the present embodiment cooperates with the tampering examination instruction function 50b and the tampering report function 50c to centrally control the detection of tampering with programs executed by the ECUs 40 included in the corresponding group.

The tampering examination instruction function 50b according to the present embodiment, when receiving an instruction to check for tampering from the vehicle management device 10, transmits the above-described tampering check instruction sequentially to the ECUs 40 of the corresponding group. When receiving the tampering check instruction, as described above, the ECU 40 detects the presence or absence of tampering using its own tampering detection function 40a and transmits the detection results to the tampering report function 50c.

The tampering report function 50c according to the present embodiment then transmits the detection results received sequentially from the ECUs 40 of the corresponding group to the tampering result report function 30b in the communication device 30. The tampering result report function 30b transmits the received detection results to the vehicle management device 10.

Also in this embodiment, the present disclosure can be implemented by substantially the same processing as in the above embodiment.

In this embodiment, as exemplarily illustrated in FIG. 13, the domain control unit 50, the ECUs 40, and various sensors 60 connected to the ECUs 40 are structured hierarchically in this order. Thus, a point is set at each level as exemplarily illustrated in FIG. 13, and when the total of the points corresponding to the location of an abnormality exceeds a predetermined threshold, an instruction to check for tampering may be transmitted to the above-described related vehicles or similar type of vehicles.

In the embodiment described above, program tampering is an abnormality in the present disclosure, but this is not restrictive. For example, a failure in an engine, a brake, or a light may be taken as an abnormality in the present disclosure.

In the embodiment described above, the vehicle control device 20 detects an abnormality in response to an instruction from the vehicle management device 10, but this is not restrictive. For example, at the time when the vehicle is parked, the vehicle control device 20 may detect an abnormality by itself.

In the embodiment described above, the vehicle management device 10 transmits an instruction to check for tampering at the time determined in the instruction timing determination process, but this is not restrictive. For example, an instruction to check for tampering may be transmitted every predetermined period or at random times within a predetermined period.

In the embodiment described above, when tampering is detected in a single vehicle, related vehicles or a similar type of vehicles are instructed to check for the tampering, but this is not restrictive. For example, when tampering is detected in at least a predetermined number of vehicles, related vehicles or a similar type of vehicles may be instructed to check for the tampering.

In the above embodiment, the processing of instructing all the corresponding vehicles to check for tampering may not be directed to all the vehicles but may be directed to some of the vehicles.

In the embodiment described above, the instruction unit 11A and the reception unit 11B are installed in the vehicle management device 10, whereas the detection unit 21A and the transmission unit 21B are installed in the vehicle control device 20, but this is not restrictive. For example, these units may be any one of the vehicle management device 10 and the vehicle control device 20 as long as the corresponding functions can be implemented.

In the embodiment described above, vehicles are used as moving bodies in the present disclosure, but this is not restrictive. For example, other moving bodies such as transport robots or drones may be used as moving bodies in the present disclosure.

The control unit and techniques for the control unit described in the present disclosure may be implemented by a special purpose computer including a processor programmed to execute one or more functions embodied by computer programs. Alternatively, the device and its method described in the present disclosure may be implemented by a special purpose computer including a processor composed of a dedicated hardware logic circuit. Alternatively, the device and its method described in the present disclosure may be implemented by one or more special purpose computers including a combination of a processor for executing computer programs and one or more hardware logic circuits. The computer programs may be stored in a non-transitory, tangible computer readable storage medium as instructions executed by a computer.

Although the present disclosure has been described in accordance with the embodiments, it will be understood that the disclosure is not limited to the embodiments or the structures. The disclosure encompasses various modifications and alterations falling within the range of equivalence. Additionally, various combinations and forms as well as other combinations and forms with one, more than one, or less than one element added thereto also fall within the scope and spirit of the present disclosure.

What is claimed is:

1. A moving body management device comprising:
a reception unit configured to receive a detection result of an occurrence status of an abnormality at a predetermined timing from a moving body whose moving function is stopped; and
an instruction unit configured to, when the detection result received by the reception unit indicates that an abnormality has occurred, instruct a related moving body related to the moving body to detect an occurrence status of the abnormality,
wherein the moving body is a vehicle, and
the related moving body includes at least one of (i) a vehicle owned by a service company providing a service based on a plurality of vehicles and owning the vehicle in which the abnormality has occurred, and (ii) a vehicle positioned in a zone where the vehicle in which the abnormality has occurred is parked.

2. The moving body management device according to claim 1, wherein
when the abnormality has occurred, the detection result includes detection information required to locate the abnormality.

3. The moving body management device according to claim 1, further comprising:
the instruction unit is configured to give an instruction to transmit the detection result at the predetermined timing.

4. The moving body management device according to claim 3, wherein
without a response for a predetermined period or longer from the moving body having accepted the instruction from the instruction unit, the instruction unit further instructs a similar type of moving body to detect an occurrence status of the abnormality.

5. The moving body management device according to claim 1, wherein
the predetermined timing is defined based on a standard restoration time being an expected time taken to restore the moving body.

6. A moving body control device comprising:
a detection unit configured to detect an occurrence status of an abnormality when a moving function of a moving body including the moving body control device is stopped and when a related moving body related to the moving body in which an abnormality has occurred is instructed by a moving body management device to detect the occurrence status of the abnormality; and
a transmission unit configured to transmit a detection result from the detection unit to the moving body management device,
wherein the moving body is a vehicle, and
the related moving body includes at least one of (i) a vehicle owned by a service company providing a service based on a plurality of vehicles and owning the vehicle in which the abnormality has occurred, and (ii) a vehicle positioned in a zone where the vehicle in which the abnormality has occurred is parked.

7. The moving body control device according to claim 6, wherein
when the abnormality has occurred, the detection unit performs the detection to provide detection information required to locate the abnormality.

8. A moving body management system comprising:
a moving body management device including
a reception unit configured to receive a detection result of an occurrence status of an abnormality at a predetermined timing from a moving body whose moving function is stopped, and
an instruction unit configured to, when the detection result received by the reception unit indicates that an abnormality has occurred, instruct a related moving body related to the moving body to detect an occurrence status of the abnormality; and
a moving body control device including
a detection unit configured to detect an occurrence status of an abnormality when a moving function of a moving body including the moving body control device is stopped and when a related moving body related to the moving body in which an abnormality has occurred is instructed by a moving body management device to detect the occurrence status of the abnormality, and
a transmission unit configured to transmit a detection result from the detection unit to the moving body management device;
wherein the moving body is a vehicle, and
the related moving body includes at least one of (i) a vehicle owned by a service company providing a service based on a plurality of vehicles and owning the vehicle in which the abnormality has occurred, and (ii) a vehicle positioned in a zone where the vehicle in which the abnormality has occurred is parked.

9. A moving body management method in which a computer executes a process of:
receiving a detection result of an occurrence status of an abnormality at a predetermined timing from a moving body whose moving function is stopped, and
when the detection result indicates that an abnormality has occurred, instructing a related moving body related to the moving body to detect an occurrence status of the abnormality;
wherein the moving body is a vehicle, and
the related moving body includes at least one of (i) a vehicle owned by a service company providing a service based on a plurality of vehicles and owning the vehicle in which the abnormality has occurred, and (ii) a vehicle positioned in a zone where the vehicle in which the abnormality has occurred is parked.

10. A moving body control method in which a computer executes a process of:
detecting an occurrence status of an abnormality when a moving function of a moving body including the moving body control device is stopped and when a related moving body related to the moving body in which an abnormality has occurred is instructed by a moving body management device to detect the occurrence status of the abnormality, and
transmitting a detection result to the moving body management device;
wherein the moving body is a vehicle, and
the related moving body includes at least one of (i) a vehicle owned by a service company providing a service based on a plurality of vehicles and owning the vehicle in which the abnormality has occurred, and (ii) a vehicle positioned in a zone where the vehicle in which the abnormality has occurred is parked.

11. A moving body management method comprising:
by a moving body management device, receiving a detection result of an occurrence status of an abnormality at a predetermined timing from a moving body whose moving function is stopped, and when the detection result indicates that an abnormality has occurred, instructing a related moving body related to the moving body to detect an occurrence status of the abnormality, and
by a moving body control device, detecting an occurrence status of an abnormality when a moving function of a moving body including the moving body control device is stopped and when a related moving body related to the moving body in which an abnormality has occurred is instructed by a moving body management device to detect the occurrence status of the abnormality, and transmitting a detection result to the moving body management device;
wherein the moving body is a vehicle, and
the related moving body includes at least one of (i) a vehicle owned by a service company providing a service based on a plurality of vehicles and owning the vehicle in which the abnormality has occurred, and (ii) a vehicle positioned in a zone where the vehicle in which the abnormality has occurred is parked.

12. A non-transitory computer-readable storage medium storing a moving body management program for causing a computer to:
receive a detection result of an occurrence status of an abnormality at a predetermined timing from a moving body whose moving function is stopped, and
when the detection result indicates that an abnormality has occurred, instruct a related moving body related to the moving body to detect an occurrence status of the abnormality;
wherein the moving body is a vehicle, and
the related moving body includes at least one of (i) a vehicle owned by a service company providing a service based on a plurality of vehicles and owning the vehicle in which the abnormality has occurred, and (ii) a vehicle positioned in a zone where the vehicle in which the abnormality has occurred is parked.

13. A non-transitory computer-readable storage medium storing a moving body control program for causing a computer to:
detect an occurrence status of an abnormality when a moving function of a moving body including the moving body control device is stopped and when a related moving body related to the moving body in which an abnormality has occurred is instructed by a moving body management device to detect the occurrence status of the abnormality, and
transmit a detection result to the moving body management device;
wherein the moving body is a vehicle, and
the related moving body includes at least one of (i) a vehicle owned by a service company providing a service based on a plurality of vehicles and owning the vehicle in which the abnormality has occurred, and (ii) a vehicle positioned in a zone where the vehicle in which the abnormality has occurred is parked.
